(19) United States
(12) Patent Application Publication
(10) Pub. No.: US 2022/0376387 A1
(43) Pub. Date: Nov. 24, 2022

(54) MOVABLE ANTENNA RADIATORS

(71) Applicant: Hewlett-Packard Development Company, L.P., Spring, TX (US)

(72) Inventors: Chin-Hung MA, Taipei (TW); Min-Hsu Chuang, Taipei (TW); Shih-Huang Wu, Spring, TX (US)

(21) Appl. No.: 17/326,437

(22) Filed: May 21, 2021

(51) Int. Cl. H01Q 3/06; H01Q 1/42; H01Q 1/24

(52) U.S. Cl. CPC H01Q 3/06; H01Q 1/42; H01Q 1/243

(57) ABSTRACT

An electronic device may include a housing, an antenna radiator disposed within the housing, a transceiver to connect to the antenna radiator, and a magnet disposed on the antenna radiator. When the magnet is aligned with a magnetic element of an input pen, the magnet may cause the antenna radiator to move proximate to a metal structure of the input pen such that the metal structure and the antenna radiator form an extended antenna.

### BACKGROUND

A stylus/input pen may be used as an input device for an electronic device that has a touchscreen. In this manner, the stylus may be used to interact with the touchscreen for purposes of inputting commands, selecting options presented in a graphical user interface (GUI), scrolling within a window of the GUI, drawing images, and so forth. The stylus may be a passive stylus, which does not include electronic components. The passive stylus may provide an input to the electronic device by physically contacting the touchscreen. The stylus may be an active stylus that contains electronic components. The active stylus may allow an input to be communicated to the computing device wirelessly (e.g., via Bluetooth) without the stylus physically contacting the touchscreen. Further, the electronic devices may include a retainer assembly to removably hold the stylus.

### BRIEF DESCRIPTION OF THE DRAWINGS

Examples are described in the following detailed description and in reference to the drawings, in which:

FIG. 1A is a schematic top view of an example electronic device, depicting an antenna radiator in a first position when an input pen is detached from a housing of the electronic device;

FIG. 1B is a schematic top view of the example electronic device of FIG. 1A, depicting the antenna radiator in a second position when the input pen is attached to the housing;

FIG. 2A is a schematic top view of a portion of the example electronic device of FIGS. 1A and 1B, depicting an elastic member to retain the antenna radiator in the first position;

FIG. 2B is a schematic top view of the portion of the example electronic device of FIG. 2A, depicting additional features;

FIG. 3 is a perspective view of the example electronic device of FIG. 1A, depicting additional features;

FIG. 4A is a schematic top view of an example electronic device, depicting a position of a first antenna radiator and a second antenna radiator when an input pen is detached from a first housing of the electronic device;

FIG. 4B is a schematic top view of the example electronic device of FIG. 4A, depicting a modified position of the first antenna radiator and the second antenna radiator when the input pen is attached to the first housing;

FIG. 4C is a schematic top view of the example electronic device of FIG. 4B, depicting additional features;

FIGS. 5A and 5B are schematic top views of the example electronic device of FIGS. 4A-4C, depicting the second antenna radiator slidably connected to the first housing;

FIG. 6A is a schematic top view of an example electronic device, depicting an antenna radiator of an input pen in a first position when the input pen is detached from a first housing of the electronic device; and

FIG. 6B is a schematic top view of the example electronic device of FIG. 6A, depicting the antenna radiator in a second position when the input pen is attached to the first housing.

### DETAILED DESCRIPTION

Electronic devices, such as tablets, smart phones, laptops, and the like, are increasingly being used in connection with an input pen or stylus as an input modality. The input pen may be used to interact with a user interface of an electronic device. Some example interactions by the input pen may include entering text, making selections, or providing input to a touch screen. The input pen can also be used as a digital pen to provide a user with handwriting experience.

Further, the electronic device may include an antenna to enable the electronic device to communicate wirelessly with other devices and communication networks. The antenna may be used in the electronic device for receiving and transmitting wireless signals at different frequencies. The term “antenna” may refer to a device that emits or receives radio waves. The antenna may be used with a transmitter. In this example, the transmitter may generate a radio signal, which may be an alternating current. The antenna may emit the radio signal as electromagnetic energy termed radio waves. The antenna may also be used with a receiver. In this example, the receiver may receive a radio signal from the antenna and convert the information carried by the radio signal into a usable form. A wireless communications circuit including both the transmitter and the receiver may be termed as a transceiver or a radio device. The transceiver may transmit and/or receive a radio frequency signal via the antenna.

In some examples, the electronic device may include a stylus retainer assembly to hold the input pen to a side of the electronic device when the input pen is not in use to enhance user experience and convenience. For example, the electronic device may include a first magnet and the input pen may include a second magnet. The first and second magnets may be aligned with each other to attach the input pen to a side of the electronic device. Further, for designing a significantly narrow border display screen of the electronic device, the antenna may be placed, for instance, in a palm rest area of a base housing (e.g., keyboard housing) of the electronic device. In this example, when the input pen is attached to the side of the electronic device and is in an active state, the performance of the antenna may be impacted as the active input pen may hinder the signals of the antenna.

In other examples, with increasing applications of the input pen, the input pen may include multiple electronic components such as sensors (e.g., an actuator, a force sensor, an accelerometer sensor, a gyro sensor, and the like) and other components (e.g., an active stylus controller, an audio component, and the like) to support such applications. To enable these and other interactions, the electronic components may require power. Further, a battery used to power the electronic components of the input pen may have a limited time during which the battery can provide power to the input pen to support various interactions. The battery life of the input pen may impact the input pen usage and function. In some cases, the electronic components inside the active input pen can draw power from the battery (e.g., Li-ion battery) even when the input pen is not in use (i.e., when the input pen is attached to the electronic device), which can reduce the battery life and can result in poor user experience while using the active stylus.

Examples described herein may provide an electronic device having a movable antenna radiator to improve an antenna performance when an input pen is attached to the electronic device. In an example, the electronic device may include a housing, a first antenna radiator, a first transceiver to connect to the first antenna radiator, and a first magnet disposed on the first antenna radiator. When the first magnet is aligned with a magnetic element of an input pen (i.e., when the input pen is attached to the housing), the first magnet may cause the first antenna radiator to move proximate to a metal structure of the input pen such that the metal structure and the first antenna radiator form an extended antenna. In an example, the metal structure of the input pen may be a coupler that is used to attach the input pen to the housing, an antenna radiator of the input pen, a conductive outer body of the input pen, or any combination thereof. Thus, examples described herein may enhance the performance of the first antenna radiator of the electronic device when the active input pen is attached to the housing of the electronic device.

In another example, the input pen may include a second antenna radiator, a second transceiver to connect to the second antenna radiator, and a second magnet disposed on the second antenna radiator. When the second magnet is aligned with a magnetic element of the electronic device (i.e., when the input pen is attached to the housing), the second magnet of the input pen may cause the second antenna radiator to move from a first position to a second position, where the second antenna radiator is disconnected from the second transceiver. Thus, the input pen may become inactive when the input pen is attached to the housing of the electronic device to reduce the power consumption of the input pen.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

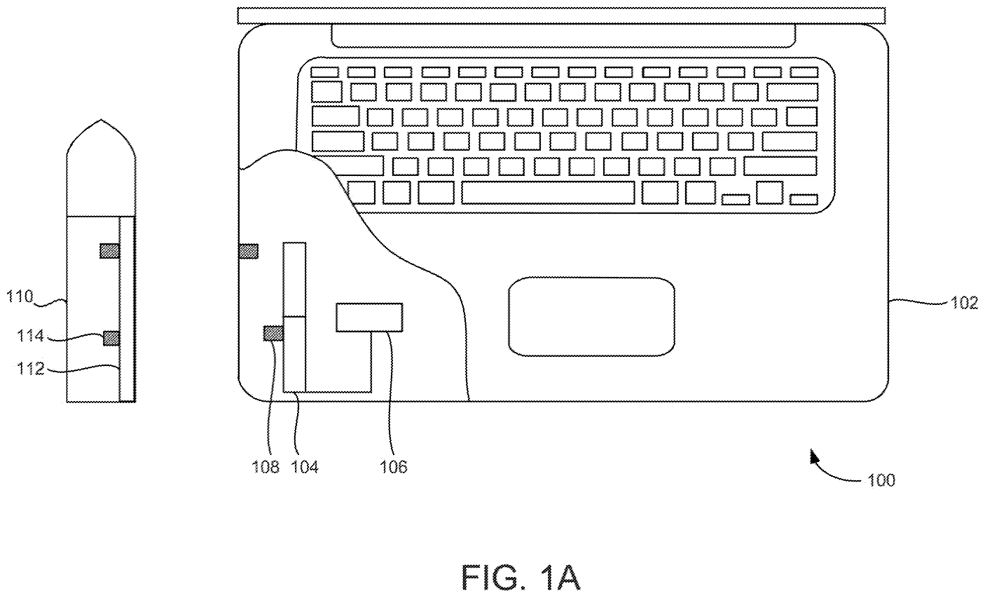

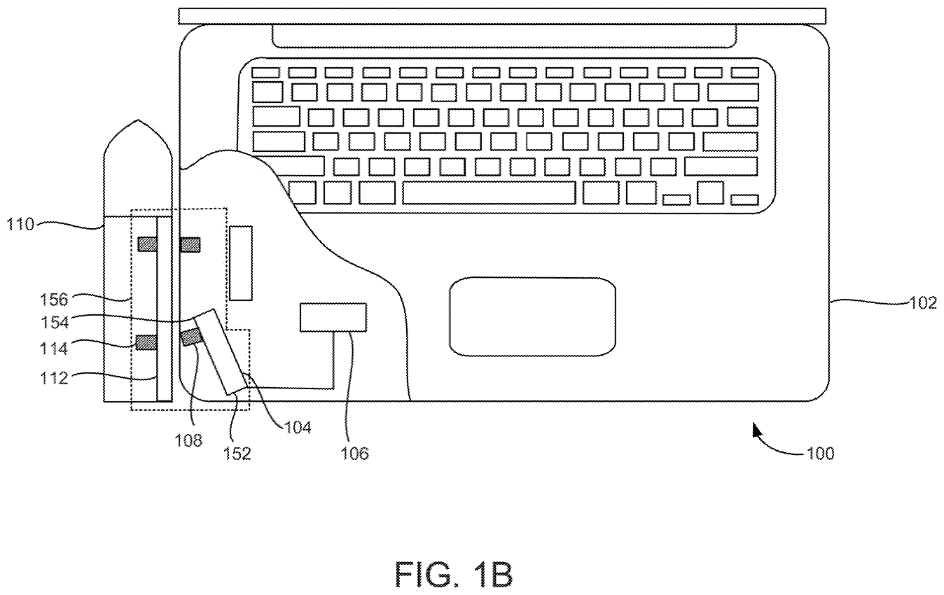

Turning now to the figures, FIG. 1A is a schematic top view of an example electronic device 100, depicting an antenna radiator 104 in a first position when an input pen 110 is detached from a housing 102 of electronic device 100. Example input pen 110 may be an electronic pen or stylus with hover detection that can provide input to electronic device 100 when input pen 110 is within a vicinity of electronic device 100 or when input pen 110 contacts electronic device 100. Further, input pen 110 may be detachably connected to electronic device 100.

Example electronic device 100 may include a notebook computer, a tablet computer, a gaming laptop, a convertible device, a smartphone, or the like. An example convertible device may refer to a device that can be “converted” from a laptop mode to a tablet mode. In the tablet mode, a display housing may be closed with a display panel facing up and viewable, i.e., the display housing may be substantially parallel to and adjacent to a base housing.

As shown in FIG. 1A, electronic device 100 may include housing 102. Further, electronic device 100 may include antenna radiator 104 disposed within housing 102. Antenna radiator 104 may facilitate in radiating radio waves. An antenna radiator may refer to a part of an antenna, which is made of electrically conductive material such as metal (e.g., copper). The antenna radiator may carry changing electric and magnetic fields. For example, antenna radiator 104 may have a patch-shape, a T-shape, inverted F-shape, or any other shape that radiates and receives radio waves. In another example, the antenna may include a dipole antenna, monopole antenna, patch antenna, loop antenna, microstrip antenna, or any other type of antenna suitable for transmission of radio frequency signals. Further, antenna radiator 104 may transmit signals over a single frequency band or multiple frequency bands.

Further, electronic device 100 may include a transceiver 106 to connect to antenna radiator 104. Transceiver 106 may be a device or circuit that is able to both transmit and receive the radio frequency signals via antenna radiator 104. In an example, transceiver 106 may be a wireless local area network (WLAN) device to establish a WLAN connection, a wireless wide area network (WWAN) device to establish a WWAN connection, or the like. The WWAN device may be operable to process the WWAN radio frequency signals from the antenna and/or generate and output WWAN radio frequency signals to the antenna to send out. The WLAN device may be operable to process the WLAN radio frequency signals from the antenna and/or generate and output WLAN radio frequency signals to the antenna to send out. In other examples, transceiver 106 may be a wireless personal area network (WPAN) device to establish a WPAN connection (e.g., a Bluetooth, Ultra-Wideband (UWB), a Near-Field Communication (NFC), ZigBee, an Infrared communication, or the like), a wireless metropolitan area network (WMAN), or the like.

As shown in FIG. 1A, electronic device 100 may include a magnet 108 disposed on antenna radiator 104. For example, magnet 108 may provide a magnetic force to retain input pen 110 when input pen 110 is attached to housing 102. Further, input pen 110 may include a metal structure 112 and a magnetic element 114. Example metal structure 112 may be a coupler that is used to attach input pen 110 to housing 102. In the example shown in FIG. 1A, input pen 110 is in a detached position from housing 102. In this example, antenna radiator 104 may be in the first position.

Further, when magnet 108 is aligned with magnetic element 114 of input pen 110 (i.e., input pen 110 is attached to housing 102), magnet 108 may cause antenna radiator 104 to move proximate to metal structure 112 of input pen 110 such that metal structure 112 and antenna radiator 104 may form an extended antenna. In this example, metal structure 112 may be used by antenna radiator 104 to extend a length of the antenna. An example extended antenna is depicted in FIG. 1B.

FIG. 1B is a schematic top view of example electronic device 100 of FIG. 1A, depicting antenna radiator 104 in a second position when input pen 110 is attached to housing 102. For example, similarly named elements of FIG. 1B may be similar in structure and/or function to elements described with respect to FIG. 1A. As shown in FIG. 1B, antenna radiator 104 may include a base end 152 pivotally connected to housing 102. Further, antenna radiator 104 may include a distal end 154. In an example, attachment of input pen 110 to housing 102 may cause magnet 108 to move antenna radiator 104 from the first position (e.g., as show in FIG. 1A) to the second position (e.g., as shown in FIG. 1B), where distal end 154 may be proximate to metal structure 112. In this example, metal structure 112 and antenna radiator 104 may form an extended antenna (e.g., as shown by dotted lines 156 in FIG. 1B).

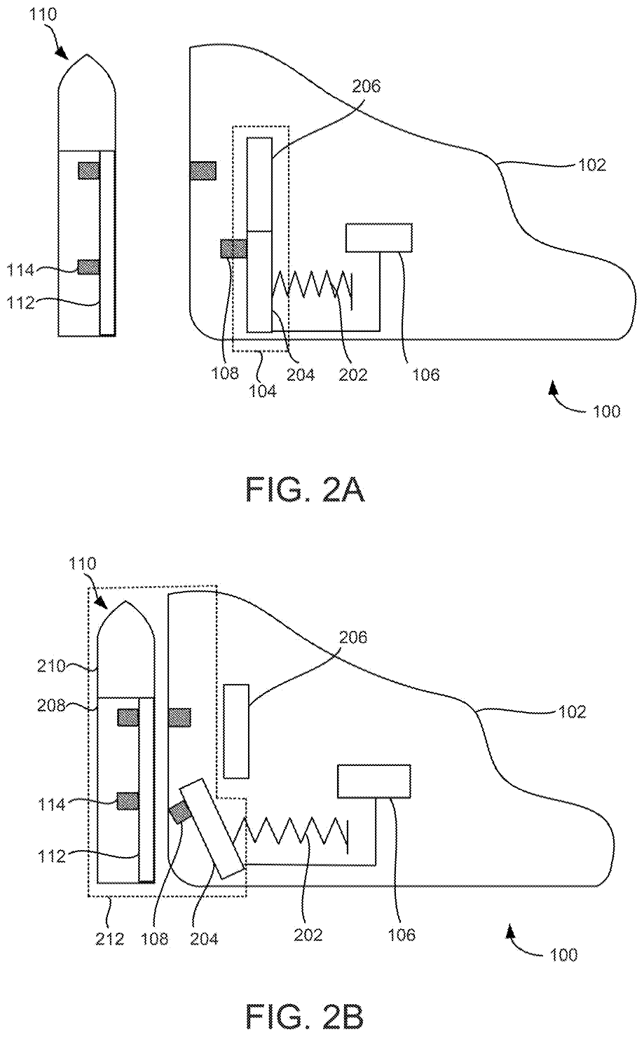

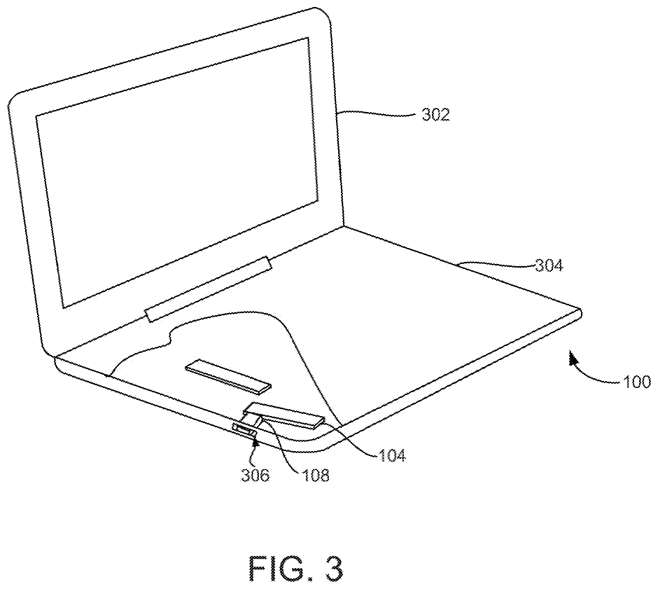

FIG. 2A is a schematic top view of a portion of example electronic device 100 of FIGS. 1A and 1B, depicting an elastic member 202 to retain antenna radiator 104 in the first position. For example, similarly named elements of FIG. 2A may be similar in structure and/or function to elements described with respect to FIGS. 1A and 1B. As shown in FIG. 2A, electronic device 100 may include elastic member 202 (e.g., a spring) connected to antenna radiator 104 and housing 102.

Further, antenna radiator 104 may include a first portion 204 and a second portion 206 connected to first portion 204. When magnet 108 is aligned with magnetic element 114, magnet 108 may cause first portion 204 to disconnect from second portion 206 and move proximate to metal structure 112, for instance, as shown in FIG. 2B.

FIG. 2B is a schematic top view of the portion of example electronic device 100 of FIG. 2A, depicting additional features. For example, similarly named elements of FIG. 2B may be similar in structure and/or function to elements described with respect to FIG. 2A. In an example, detachment of input pen 110 from housing 102 may cause elastic member 202 to move first portion 204 from the second position (e.g., as shown in FIG. 2B) to the first position (e.g., as shown in FIG. 2A). Thus, when input pen 110 is detached from housing 102, antenna radiator 104 or first portion 204 of antenna radiator 104 may be moved to the first position because of a force applied by elastic member 202.

In other examples, input pen 110 may include a non-conductive material 208 (e.g., plastic) and a conductive material 210 (e.g., a metal). Further, metal structure 112 and magnetic element 114 may be disposed in non-conductive material 208. As shown in FIG. 2B, metal structure 112 may be connected to conductive material 210. In this example, when magnet 108 is aligned with magnetic element 114 of input pen 110, magnet 108 may cause first portion 204 to move proximate to metal structure 112 of input pen 110 such that metal structure 112, conductive material 210, and first portion 204 may form the extended antenna (e.g., as shown by dotted lines 212).

Examples described in FIGS. 1A, 1B, 2A, and 2B may be implemented in a passive input pen, which may not include electronic components. Further, with examples described herein, a low band lower spectrum frequency of the antenna may be improved as metal structure 112 and/or a metal housing (e.g., conductive material 210) of input pen 110 may be used to extend a length of antenna radiator 104.

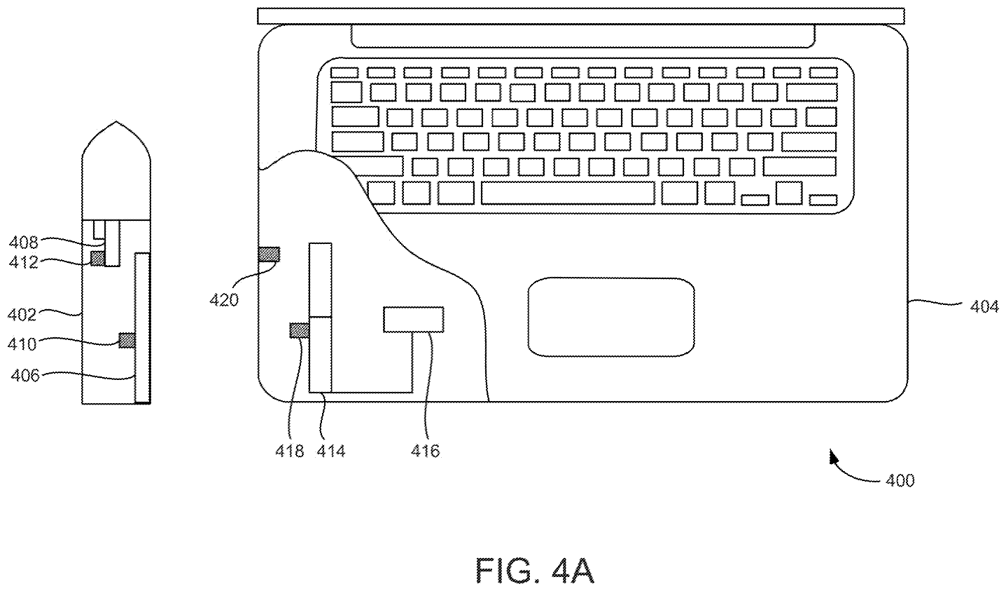

FIG. 3 is a perspective view of example electronic device 100 of FIG. 1A, depicting additional features. For example, similarly named elements of FIG. 3 may be similar in structure and/or function to elements described with respect to FIG. 1A. Example electronic device 100 may be a laptop computer having a base housing 304 and a display housing 302 that may be rotatably, detachably, or twistably connected to base housing 304. For example, base housing 304 may house a keyboard, a battery, a touchpad, and so on. Display housing 302 may house a display panel (e.g., a touchscreen display panel). Example display panel may include liquid crystal display (LCD), light emitting diode (LED), electro-luminescent (EL) display, or the like. In other examples, display housing 302 and base housing 304 may house other components such as a camera, audio/video devices, and the like, depending on the functions of electronic device 100.

As shown in FIG. 3, base housing 304 (e.g., housing 102 of FIG. 1A) may include an opening 306. In an example, when magnet 108 is aligned with magnetic element 114 of input pen 110 as shown in FIG. 1B, antenna radiator 104 may move proximate to metal structure 112 of input pen 110 and physically contact metal structure 112 through opening 306 to enhance the performance of antenna radiator 104. In other examples, opening 306 may be covered with a metal substrate such that the metal substrate can contact magnet 108/antenna radiator 104 and metal structure 112 when input pen 110 is attached to base housing 304.

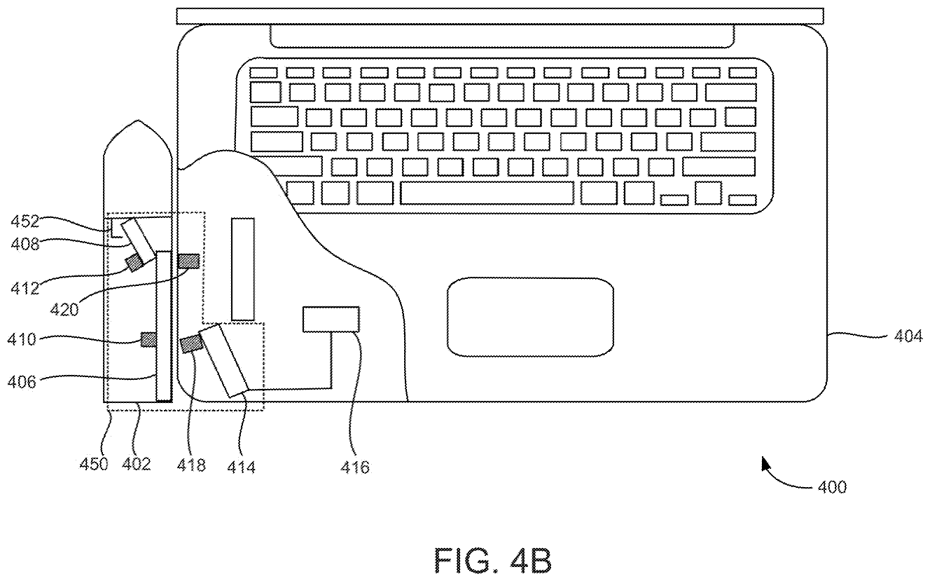

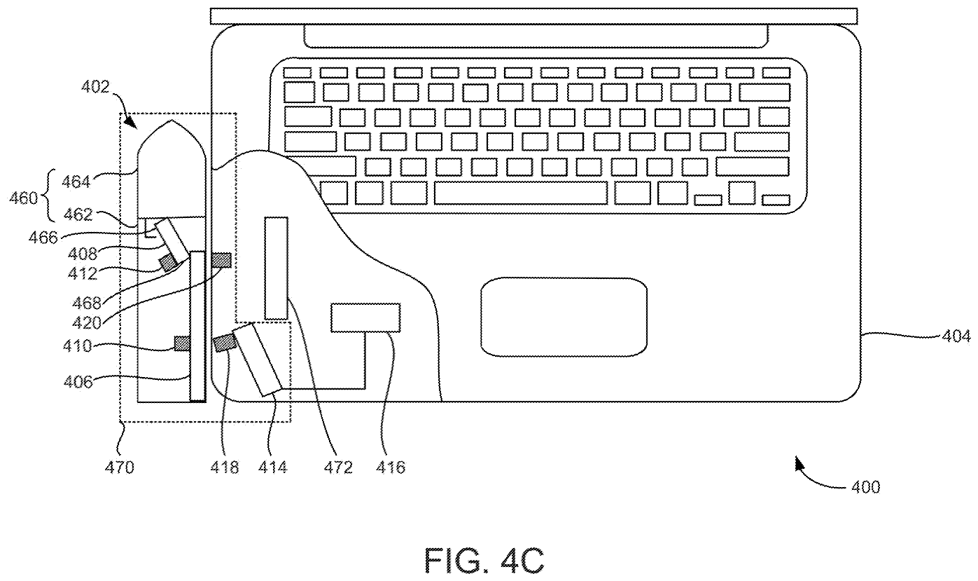

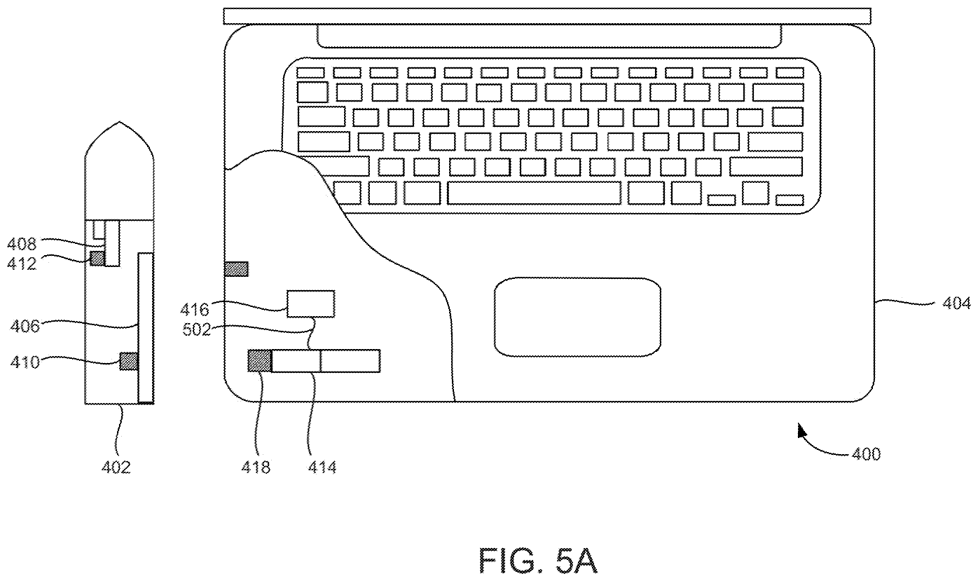

FIG. 4A is a schematic top view of an example electronic device 400, depicting a position of a first antenna radiator 408 and a second antenna radiator 414 when an input pen 402 is detached from a first housing 404 of electronic device 400. Electronic device 400 may include input pen 402. In an example, input pen 402 may be an active pen, which may be an input device that includes electronic components. For example, the active pen may allow an input to be communicated to electronic device 400 wirelessly (e.g., via Bluetooth). Further, input pen 402 may be detachably connected to electronic device 400.

As shown in FIG. 4A, input pen 402 may include a metal structure 406, first antenna radiator 408, a first magnetic element 410, and a second magnetic element 412 disposed on first antenna radiator 408. For example, first antenna radiator 408 may be connected to a radio device or transceiver via a feedline (e.g., a feedline 452 as shown in FIG. 4B) to receive an input. Further, electronic device 400 may include first housing 404 to removably hold input pen 402. Further, first housing 404 may include second antenna radiator 414, a transceiver 416 to connect to second antenna radiator 414, a first magnet 418 disposed on second antenna radiator 414, and a second magnet 420.

In an example, first antenna radiator 408 may be pivotally connected within input pen 402. Further, second antenna radiator 414 may be pivotally connected to first housing 404. In the example shown in FIG. 4A, input pen 402 is in a detached position from first housing 404. In this example, first antenna radiator 408 and second antenna radiation 414 may be in the first position as shown in FIG. 4A. When first magnet 418 and second magnet 420 are aligned with first magnetic element 410 and second magnetic element 412, respectively, first antenna radiator 408 and second antenna radiation 414 may be moved to a second position, as described in FIG. 4B.

FIG. 4B is a schematic top view of example electronic device 400 of FIG. 4A, depicting a modified position of first antenna radiator 408 and second antenna radiator 414 when input pen 402 is attached to first housing 404. For example, similarly named elements of FIG. 4B may be similar in structure and/or function to elements described with respect to FIG. 4A. As shown in FIG. 4B, when first magnet 418 and second magnet 420 are aligned with first magnetic element 410 and second magnetic element 412, respectively:
first magnet 418 may cause second antenna radiator 414 to move in a direction (e.g., a first direction) proximate to metal structure 406, and
second magnet 420 may cause first antenna radiator 408 to contact metal structure 406 such that metal structure 406, first antenna radiator 408, and second antenna radiator 414 may form an extended antenna (e.g., as shown by dotted lines 450). In this example, feedline 452 may be disconnected from first antenna radiator 408 in the second position, for instance, to disable a wireless connection (e.g., Bluetooth) of input pen 402.

FIG. 4C is a schematic representation of electronic device 400 of FIG. 4B, depicting additional features. For example, similarly named elements of FIG. 4C may be similar in structure and/or function to elements described with respect to FIG. 4B. As shown in FIG. 4C, input pen 402 may include a second housing 460 including a non-conductive material 462 and a conductive material 464. In an example, metal structure 406, first antenna radiator 408, first magnetic element 410, and second magnetic element 412 may be disposed in non-conductive material 462.

Further, first antenna radiator 408 may include a first end 466 pivotally connected to conductive material 464 and a second end 468. In this example, when second magnet 420 is aligned with second magnetic element 412, second magnet 420 may move second end 468 to ground first antenna radiator 408 to metal structure 406 such that metal structure 406, first antenna radiator 408, conductive material 464, and second antenna radiator 414 may form an extended antenna (e.g., as shown by dotted lines 470).

Furthermore, electronic device 400 may include a third antenna radiator 472 disposed in first housing 404. In an example, detachment of input pen 402 from first housing 404 may allow second antenna radiator 414 to move in an opposite direction (i.e., opposite to the first direction) to contact third antenna radiator 472 such that second antenna radiator 414 and third antenna radiator 472 may form an antenna for electronic device 400.

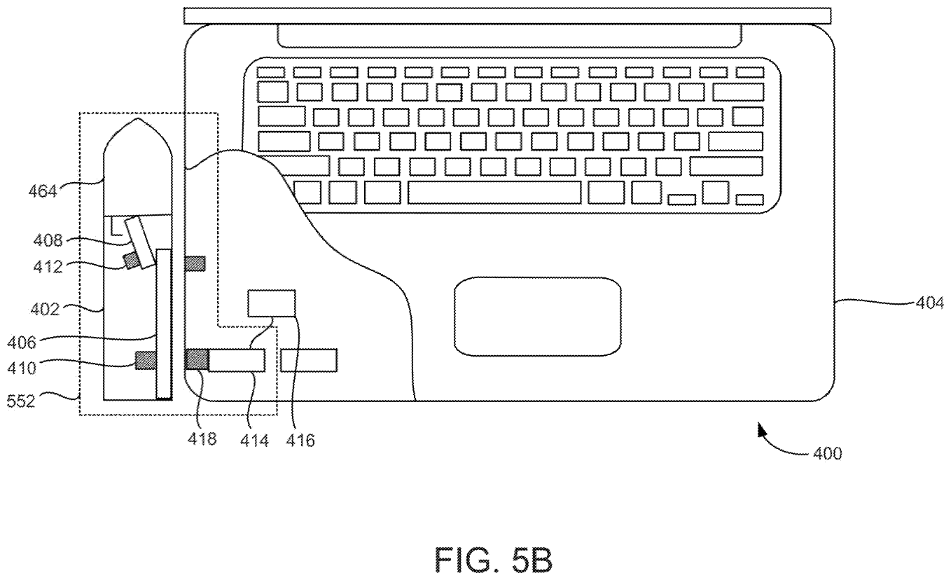

FIGS. 5A and 5B are schematic top views of example electronic device 400 of FIGS. 4A-4C, depicting second antenna radiator 414 slidably connected to first housing 404. For example, similarly named elements of FIGS. 5A and 5B may be similar in structure and/or function to elements described with respect to FIGS. 4A-4C. As shown in FIG. 5A, second antenna radiator 414 may be slidably connected to first housing 404 of electronic device 400. In an example, electronic device 400 may include a feedline 502 to connect antenna radiator 414 and transceiver 416. An example feedline may refer to a cable (e.g., a transmission line). During operation, feedline 502 may feed radio waves to various components of antenna radiator 414.

Further, first magnet 418, that may be used to attach input pen 402 to first housing 404, may be disposed on a side of second antenna radiator 414. As shown in FIG. 5B, when input pen 402 is attached to first housing 404, second antenna radiator 414 may slide in a direction proximate to metal structure 406 such that that metal structure 406, first antenna radiator 408, conductive material 464, and second antenna radiator 414 may form an extended antenna (e.g., as shown by dotted lines 552).

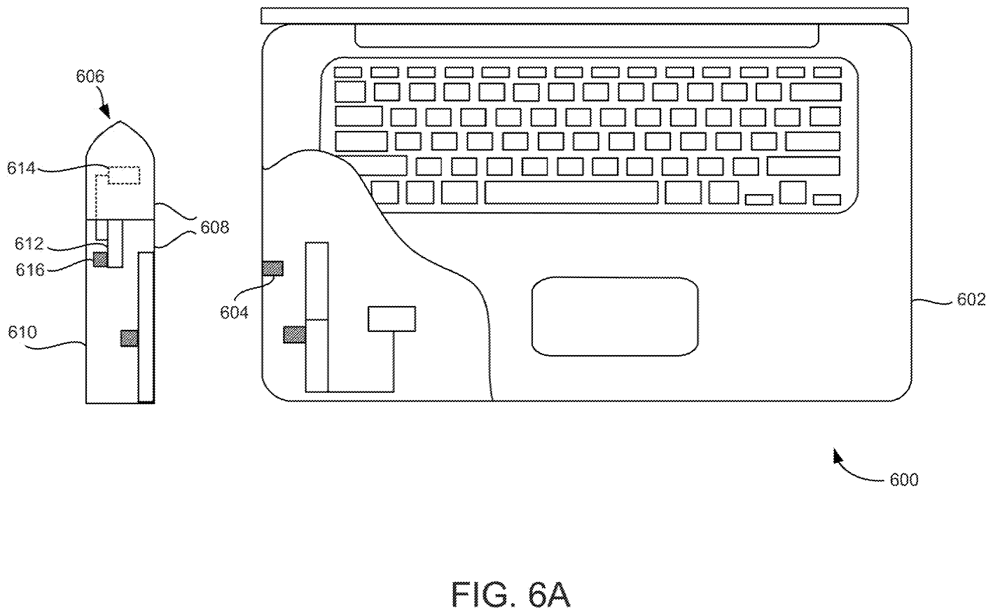

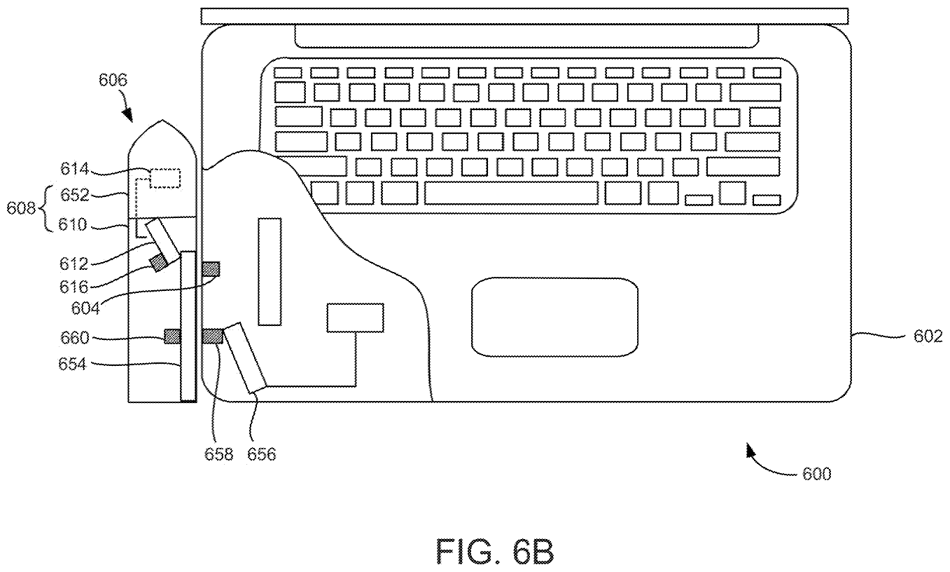

FIG. 6A is a schematic top view of an example electronic device 600, depicting an antenna radiator 612 of an input pen 606 in a first position when input pen 606 is detached from a first housing 602 of electronic device 600. As shown in FIG. 6A, electronic device 600 may include first housing 602 including a first host magnet 604. Further, electronic device 600 may include input pen 606 detachably connected to first housing 602.

Further, input pen 606 may include a second housing 608 having a non-conductive material 610. Further, input pen 606 may include antenna radiator 612 disposed within second housing 608. Furthermore, input pen 606 may include a transceiver 614 to connect to antenna radiator 612. Example transceiver 614 may be a Bluetooth-enabled device to send and receive Bluetooth signals. In other examples, transceiver 614 may be an Ultra-Wideband (UWB) device, a Near-Field Communication (NFC) device, a ZigBee device, an Infrared communication device, or any other short range wireless communication device.

Further, input pen 606 may include a first magnet 616 disposed on antenna radiator 612. In an example, when first magnet 616 is aligned with first host magnet 604, first magnet 616 may cause antenna radiator 612 to move from a first position to a second position where antenna radiator 612 is disconnected from transceiver 614, as depicted in FIG. 6B. In this example, disconnection of antenna radiator 612 from transceiver 614 may cause transceiver 614 or a radio device (e.g., a Bluetooth radio device) to be turned off, thereby enhancing a battery performance of input pen 606.

FIG. 6B is a schematic top view of example electronic device 600 of FIG. 6A, depicting antenna radiator 612 in the second position when input pen 606 is attached to first housing 602. For example, similarly named elements of FIG. 6B may be similar in structure and/or function to elements described with respect to FIG. 6A. In an example, second housing 608 may include a conductive material 652 and non-conductive material 610. Further, antenna radiator 612 may include a first end pivotally connected to conductive material 652 as shown in FIG. 6B. Furthermore, input pen 606 may include a metal structure 654 disposed at non-conductive material 610. In an example, antenna radiator 612 may include a second end to connect to metal structure 654 in the second position as shown in FIG. 6B.

Further, first housing 602 may include a host antenna radiator 656 and a second host magnet 658 disposed on host antenna radiator 656. Furthermore, input pen 606 may include a second magnet 660 disposed in second housing 608. In an example, when second magnet 660 is aligned with second host magnet 658, second magnet 660 may cause host antenna radiator 656 to move from a first position to a second position where an end of host antenna radiator 656 may be proximate to metal structure 654 as shown in FIG. 6B.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
a housing;
an antenna radiator disposed within the housing;
a transceiver to connect to the antenna radiator; and
a magnet disposed on the antenna radiator, wherein when the magnet is aligned with a magnetic element of an input pen, the magnet is to cause the antenna radiator to move proximate to a metal structure of the input pen such that the metal structure and the antenna radiator form an extended antenna.

2. The electronic device of claim 1, wherein the antenna radiator comprises:
a base end pivotally connected to the housing; and
a distal end, wherein attachment of the input pen to the housing causes the magnet to move the antenna radiator from a first position to a second position where the distal end is proximate to the metal structure.

3. The electronic device of claim 2, further comprising:
an elastic member connected to the antenna radiator and the housing, wherein detachment of the input pen from the housing causes the elastic member to move the antenna radiator from the second position to the first position.

4. The electronic device of claim 1, wherein the housing comprises an opening, wherein when the magnet is aligned with the magnetic element of the input pen, the antenna radiator is to move proximate to the metal structure and physically contact the metal structure through the opening.

5. The electronic device of claim 1, wherein the antenna radiator comprises a first portion and a second portion connected to the first portion, and wherein when the magnet is aligned with the magnetic element, the magnet is to cause the first portion to disconnect from the second portion and move proximate to the metal structure.

6. An electronic device comprising:
an input pen comprising:
a metal structure;
a first antenna radiator;
a first magnetic element; and
a second magnetic element disposed on the first antenna radiator;
and
a first housing to removably hold the input pen, the first housing comprising:
a second antenna radiator;
a transceiver to connect to the second antenna radiator;
a first magnet disposed on the second antenna radiator; and
a second magnet, wherein when the first magnet and the second magnet are aligned with the first magnetic element and the second magnetic element, respectively:
the first magnet is to cause the second antenna radiator to move in a direction proximate to the metal structure; and
the second magnet is to cause the first antenna radiator to contact the metal structure such that the metal structure, the first antenna radiator, and the second antenna radiator form an extended antenna.

7. The electronic device of claim 6, wherein the input pen comprises:
a second housing comprising a non-conductive material and a conductive material, and wherein the metal structure, the first antenna radiator, the first magnetic element, and the second magnetic element are disposed in the non-conductive material.

8. The electronic device of claim 7, wherein the first antenna radiator comprises a first end pivotally connected to the conductive material and a second end.

9. The electronic device of claim 8, wherein when the second magnet is aligned with the second magnetic element, the second magnet is to move the second end to ground the first antenna radiator to the metal structure such that the metal structure, the first antenna radiator, the conductive material, and the second antenna radiator form the extended antenna.

10. The electronic device of claim 6, further comprising a third antenna radiator disposed in the first housing.

11. The electronic device of claim 10, wherein detachment of the input pen from the first housing allows the second antenna radiator to move in an opposite direction to contact the third antenna radiator such that the second antenna radiator and the third antenna radiator form an antenna.

12. The electronic device of claim 6, wherein the second antenna radiator is pivotally connected to the first housing.

13. The electronic device of claim 6, wherein the second antenna radiator is slidably connected to the first housing.

14. An electronic device comprising:
a first housing comprising a first host magnet; and
an input pen detachably connected to the first housing, wherein the input pen comprises:
a second housing comprising a non-conductive material;
an antenna radiator disposed within the second housing;
a transceiver to connect to the antenna radiator; and
a first magnet disposed on the antenna radiator, wherein when the first magnet is aligned with the first host magnet, the first magnet is to cause the antenna radiator to move from a first position to a second position where the antenna radiator is disconnected from the transceiver.

15. The electronic device of claim 14, wherein the second housing comprises:
a conductive material, wherein the antenna radiator comprises a first end pivotally connected to the conductive material.

16. The electronic device of claim 15, wherein the input pen comprises:
a metal structure disposed at the non-conductive material, wherein the antenna radiator comprises a second end to connect to the metal structure in the second position.

17. The electronic device of claim 16, wherein the first housing comprises a host antenna radiator and second host magnet disposed on the host antenna radiator.

18. The electronic device of claim 17, wherein the input pen comprises a second magnet disposed in the second housing.

19. The electronic device of claim 18, wherein when the second magnet is aligned with the second host magnet, the second magnet is to cause the host antenna radiator to move from a first position to a second position where an end of the host antenna radiator is proximate to the metal structure.

20. The electronic device of claim 14, wherein the transceiver is a Bluetooth-enabled device to send and receive Bluetooth signals.
